(19) United States
(12) Patent Application Publication
(10) Pub. No.: US 2022/0358466 A1
(43) Pub. Date: Nov. 10, 2022

(54) SYSTEMS, METHODS, AND APPARATUSES FOR EMPLOYMENT MANAGEMENT

(71) Applicant: OLME.US LLC, New York, NY (US)

(72) Inventors: Ariella Azogui, New York, NY (US); Marcus Hoed, New York, NY (US)

(73) Assignee: OLME.US LLC, New York, NY (US)

(21) Appl. No.: 17/736,982

(22) Filed: May 4, 2022

Related U.S. Application Data
(60) Provisional application No. 63/184,185, filed on May 4, 2021.

(51) Int. Cl. G06Q 10/10; G06Q 10/06; H04L 51/02

(52) U.S. Cl. CPC G06Q 10/1053; G06Q 10/1093; G06Q 10/0639; H04L 51/02

(57) ABSTRACT

The invention of the present disclosure may be a computer system for employment management comprising stored program instructions comprising receiving a depository of applicants, sourcing one or more candidates from the depository of applicants via a virtual chat-bot configured to deliver messages to each of the one or more applicants, screening, via the one or more processors, the one or more candidates for one or more prospective hires via the virtual chat-bot adapted to filter the one or more candidates based on a predetermined position criteria set, generating, via the one or more processors, and displaying to the one or more employees, via one or more screens, a gamified training session, and tracking, via the one or more processors, violations of each of the one or more employees, each violation comprising at least a violation date, a violation time, and a violation type.

### CLAIM OF PRIORITY

This application claims priority from U.S. Provisional Patent Application No. 63/184,185, filed on May 4, 2021, the contents of which are incorporated herein by reference.

### FIELD OF THE INVENTION

This disclosure relates to systems, methods, and apparatuses for employment management. Specifically, this disclosure relates to systems, methods, and apparatuses for internal management regarding employment procedures for a delivery associate labor force.

### INTRODUCTION

The majority of companies in the “gig” economy hire individuals as 1099—Independent Contractors. Unfortunately, when doing so, the individual contractor is less connected to their work and/or company. Thus, the contractor does not always demonstrate a commitment in their attendance, which impacts performance. This issue also raises serious liability concerns for companies because state and federal agencies closely review misclassification of individuals working with companies in “gig” industries.

Many “gig” industries do not work with 1099—Independent Contractors (for example, for delivery associate positions). Many of these workers are hired as W2 employees. This enables many of these companies to control scheduling. Controlling scheduling also enables the company to better meet clients' staffing needs, set enforceable performance standards for delivery associates, cross train employees among various client groups/operations and, finally, insulate the company from exposure to any misclassification liability.

The labor pool for the delivery associate positions are lower level, entry level, minimum wage workers with limited or no work experience (for example, may of these types of workers only have high school level education). Accordingly, many of these workers are not familiar with integrated systems that contain “user portals,” updated technology, digital e-filing, electronic hours tracking, and other modern employment software aspects.

Often, these kinds of workers (for example, delivery associates) work remotely, often at client sites. Since these are entry-level individuals, their ability to work independently, their ability to demonstrate ownership of their work assignments ensuring the timely delivery of goods, and/or ability to consistently follow company policy related to clock-in/clock-out protocol is limited. Moreover, training in the traditional, “old school” manner regarding these necessary behaviors is not well received among this population, as many are not comfortable with the academic-like approach to learning.

Like many entry-level positions, the individuals who are filling these roles live “pay check to pay check.” Such circumstances may create difficulties for employees who are in need of money but must wait “until the next check” to access the wages they are entitled to. Often this leads to poor attendance, frustration, and poor work habits.

Thus, it would be desirable to provide systems configured to efficiently and effectively recruit, onboard, manage, and/or offboard such workers. It would be yet further desirable to provide systems adapted to utilize an employee's smart device to manage and determine company policy violations and/or other delivery-related metrics.

### SUMMARY

In an embodiment, the invention of the present disclosure is a computer system for employment management comprising one or more processors, one or more computer-readable memories, and one or more computer-readable storage devices, and program instructions stored on at least one of the one or more computer-readable storage devices for execution by at least one of the one or more processors via at least one of the one or more computer-readable memories, the stored program instructions causing the one or more processors to receive a depository of applicants, the depository of applicants comprising an application corresponding to each of the one or more applicants; source one or more candidates from the depository of applicants via a virtual chat-bot configured to deliver messages to each of the one or more applicants; screen, via the one or more processors, the one or more candidates for one or more prospective hires via the virtual chat-bot adapted to filter the one or more candidates based on a predetermined position criteria set; and generate, via the one or more processors, a profile based on each of the one or more prospective hires. In an embodiment, the stored program instructions may further cause the one or more processors to receive a required documentation set for each of the one or more prospective hires; generate an offer letter for the one or more prospective hires; transmit the offer letter to the one or more prospective hires; receive an acceptance of the offer letter from one or more employees; and generate, via the one or more processors, and display to the one or more employees, via one or more screens, a gamified training session. In yet a further embodiment, the stored program instructions may cause the one or more processors to set a work schedule for each of the one or more employees; track, via the one or more processors, violations of each of the one or more employees, each violation comprising at least a violation date, a violation time, and a violation type, wherein the violations comprise automatically detected violations and manually input violations, wherein the automatically detected violations are evaluated by the one or more processors in view of a predetermined violation criteria set, and wherein the manually input violations are received via an administrator; create, via the one or more processors, a violation identification (“ID”) for each of the violations; store, via the one or more computer-readable storage devices, each of the violations and corresponding violation ID in a violation list; and generate, via the one or more processors, a violation report comprising the violations and corresponding violation types for the one or more employees.

In another aspect, sourcing the one or more candidates from the depository of applicants may further comprise utilizing an artificial intelligence (“AI”) applicant tracking system (“ATS”). The stored program instructions may further comprise performing a background check for each of the one or more prospective hires based on the required documentation set. In a further embodiment, the stored program instructions further comprise associating a payroll schedule with each of the one or more employee profiles, wherein the payroll schedule causes pay disbursements to each of the one or more employees.

In yet a further aspect, the stored program instructions may further comprise monitoring, via the one or more processors, attendance metrics of each of the one or more employees, wherein the attendance metrics of each of the one or more employees are a function of at least a clock in time, a clock out time, and the work schedule. In one embodiment, the stored program instructions further comprise monitoring, via the one or more processors, performance metrics of each of the one or more employees, wherein the performance metrics of each of the one or more employees are a function of at least a set of tasks. In an embodiment, the violations report comprises a violations visualization, and the violations visualization may display a predetermined number of violation types sorted by a frequency of occurrence for each of the violation types by the employees.

In an embodiment, the stored program instructions further comprise generating, via the one or more processors, a violations management module interface editable by a first administrator and a second administrator, wherein edits to the violation management module interface by the first administrator are restricted by a first permission, and wherein edits to the violation management module interface by the second administrator are restricted by a second permission. The first permission may be configured to allow entry of a geolocation of one of the manually input violations. The second permission may be configured to allow entry of a violation description of one of the manually input violations.

Additional aspects related to this disclosure are set forth, in part, in the description which follows, and, in part, will be obvious from the description, or may be learned by practice of this disclosure.

It is to be understood that both the forgoing and the following descriptions are exemplary and explanatory only and are not intended to limit the claimed disclosure or application thereof in any manner whatsoever.

These and other aspects, features, and advantages of the present invention will become more readily apparent from the following drawings and the detailed description of the preferred embodiments.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 illustrates a block diagram of a distributed computer system that can implement one or more aspects of an embodiment of the present invention.

FIG. 2 illustrates a block diagram of an electronic device that can implement one or more aspects of an embodiment of the invention.

FIG. 3 illustrates a workflow depicting an embodiment of an employment management system.

FIG. 4 illustrates an embodiment of an employee performance interface.

FIG. 5 illustrates an embodiment of a violations report interface.

FIG. 6 illustrates an embodiment of a violations metrics report interface.

FIG. 7 illustrates an embodiment of a tips interface for presentation to a user.

### DETAILED DESCRIPTION

The detailed description provided herein, along with accompanying figures, illustrates one or more embodiments, but is not intended to describe all possible embodiments. The detailed description provides exemplary systems and methods of technologies, but is not meant to be limiting, and similar or equivalent technologies, systems, and/or methods may be realized according to other examples as well.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or process the software in a distributive manner by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” as used herein typically includes and refers to executable instructions, code, data, applications, programs, program modules, or the like maintained in an electronic device such as a ROM. The term “software” as used herein typically includes and refers to computer-executable instructions, code, data, applications, programs, program modules, firmware, and the like maintained in or on any form or type of computer-readable media that is configured for storing computer-executable instructions or the like in a manner that may be accessible to a computing device.

The terms “computer-readable medium”, “computer-readable media”, and the like as used herein and in the claims are limited to referring strictly to one or more statutory apparatus, article of manufacture, or the like that is not a signal or carrier wave per se. Thus, computer-readable media, as the term is used herein, is intended to be and must be interpreted as statutory subject matter.

The term “computing device” as used herein and in the claims is limited to referring strictly to one or more statutory apparatus, article of manufacture, or the like that is not a signal or carrier wave per se, such as computing device 101 that encompasses client devices, mobile devices, wearable devices, one or more servers, network services such as an Internet services or corporate network services based on one or more computers, and the like, and/or any combination thereof. Thus, a computing device, as the term is used herein, is also intended to be and must be interpreted as statutory subject matter.

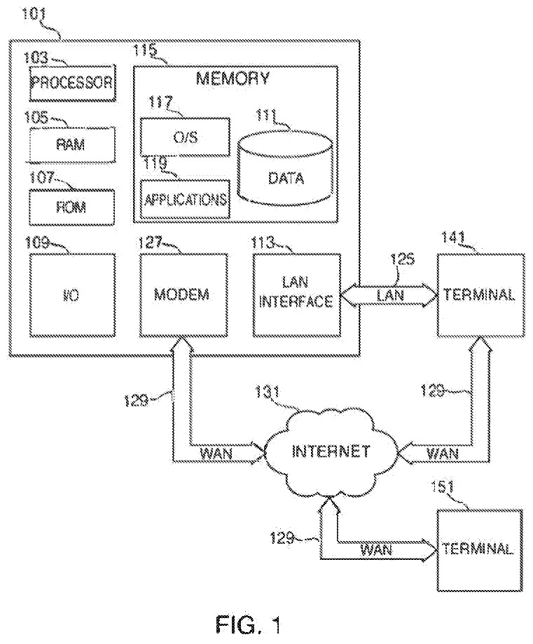

FIG. 1 is an illustrative block diagram of system 100 based on a computer 101. The computer 101 may have a processor 103 for controlling the operation of the device and its associated components, and may include RAM 105, ROM 107, input/output module 109, and a memory 115. The processor 103 will also execute all software running on the computer—e.g., the operating system. Other components commonly used for computers such as EEPROM or Flash memory or any other suitable components may also be part of the computer 101.

The memory 115 may be comprised of any suitable permanent storage technology—e.g., a hard drive. The memory 115 stores software including the operating system 117 any application(s) 119 along with any data 111 needed for the operation of the system 100. Alternatively, some or all of computer executable instructions may be embodied in hardware or firmware (not shown). The computer 101 executes the instructions embodied by the software to perform various functions.

Input/output (“I/O”) module may include connectivity to a microphone, keyboard, touch screen, display, and/or stylus through which a user of computer 101 may provide input, and may also include one or more speakers for providing audio output and a video display device for providing textual, audiovisual and/or graphical output.

System 100 may be connected to other systems via a LAN interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. As a non-limiting example, the server architecture may be divided into three parts, a front end, a back end, and a database. The front end may be opened as a URL in the user's web browser and loaded therein (for example, utilizing the browser's memory). Accordingly, the server frontend may present the various interfaces described herein to the user. The back end may be called upon by requests originating from the front end (for example, recalling the list of the users or adding a user). Each of these requests may perform a read or write operation on the database. Thus, in the database data may be stored and manipulated by the back end (for example, either read or write, wherein writing may include creation of new rows or updates to preexisting data).

Additionally, application program(s) 119, which may be used by computer 101, may include computer executable instructions for invoking user functionality related to communication, such as email, Short Message Service (SMS), and voice input and speech recognition applications.

Computer 101 and/or terminals 141 or 151 may also be devices including various other components, such as a battery, speaker, and antennas (not shown).

Terminal 151 and/or terminal 141 may be portable devices such as a laptop, cell phone, smartphone, smartwatch, or any other suitable device for storing, transmitting and/or transporting relevant information. Terminals 151 and/or terminal 141 may be other devices. These devices may be identical to system 100 or different. The differences may be related to hardware components and/or software components.

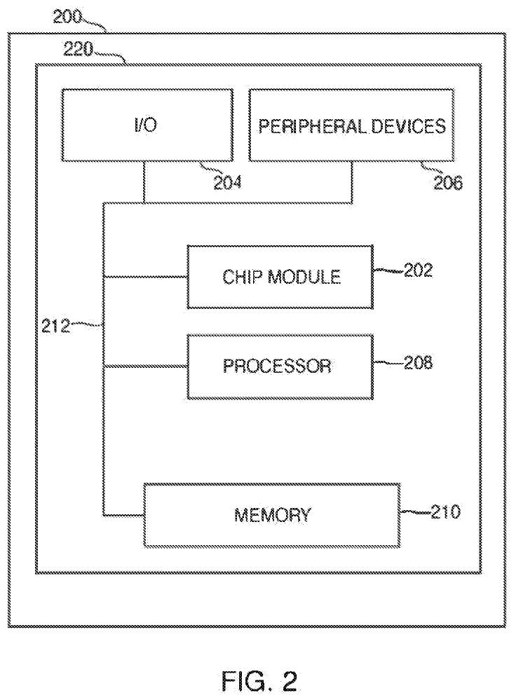

FIG. 2 shows illustrative apparatus 200. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device 208, which may test submitted information for validity, scrape relevant information, aggregate user financial data and/or provide an auth-determination score(s) and machine-readable memory 210.

Machine-readable memory 210 may be configured to store in machine-readable data structures: information pertaining to a user, information pertaining to an account holder and the accounts which he may hold, the current time, information pertaining to historical user account activity and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

Disclosed herein are systems, apparatuses, and methods (the “System”) for employee management.

In an embodiment, the System applies a “meet them where they are” in the comfort of “their own space” approach. In an embodiment, the System is configured with various system integrations. For example, the System may be designed around proprietary platforms that support employee engagement in one or more aspects. In an embodiment, the System includes End-to-End IT powered processes, which may allow the System, to “verbally walk” the employees through the various processes. Further, the System may prompt the employees in an effort to complete each step of the process. For the purposes of this disclosure, interactions with the System by an employee may occur on a computer, smart device, mobile telephone, or other electronic device, for example, as depicted by apparatus 200. However, the System may include aspects executable on the apparatus 200, computer 101, servers, and/or other electronic components as illustrated in FIGS. 1-2 and disclosed herein.

In an embodiment, the system is a proprietary platform that drives internal processes, including, but not limited to, payroll approval management, violations management, scheduling management, and key performance indicators reporting. This platform may be a board (for example, a computerized dashboard) and may be the hub for the entire technology-powered employment management process. For example, said employment management process may integrate features from multiple software suites to drive the efficiency of a business' day-to-day operations. The aforementioned board may be a Graphical User Interface (“GUI”) generated and displayed by apparatus 200.

The present disclosure may include a user management module. The user management module may include at least one digital button. The button may be activated by input via a touch screen, or via a user “clicking” the button via a mouse. In an embodiment, there is an “add user” or “create” button. Activation of such buttons may generate and display one or more add user input fields to the user. The add user input fields may allow a user to enter, via an input method, a first name, last name, email, password, role, or status of a user, for the purpose of creating a user account. Other information may include date of birth, phone number, address, or any other suitable information. The aggregation of the created user accounts may be stored in a database and may be retrieved to aid other processes described herein.

The GUI may include a “read” button. Activating the read button may display a table containing information relating to registered users. Such information may include any information entered into the add user input fields for each registered user. Additional information may include access status and user creation date. The table may also include a plurality of options displayed as buttons. These options may include “unlock/lock,” “delete,” “edit,” or any other suitable option. Information pertaining to users may be stored in an employee database in the server back end. Such a database may be displayed to the user in the front end after a request call to the back end, which induces data retrieval from the database. For example, such information may be retrieved when the user loads the corresponding page, causing a request to be sent to the back end to retrieve the users list data.

In an embodiment, the user interface includes an “update” button. Activating the update button may allow a user to edit the information originally entered into the add user input fields for a specific user.

The user interface may include a “delete” button. Activating the delete button may cause a pop-up window to appear on the display. The pop-up window may contain a confirmation message asking the user to confirm whether they wish to delete a specific user account. A user may then interact with a confirm button displayed in the pop-up window to delete a specific user account. Alternatively, the user may interact with a cancel button displayed in the pop-up window to cancel the “delete” action.

The user management module may allow for an administrator or other suitable user to unlock a user. For example, if a user is locked, another party may unlock said user via the user management module. In an embodiment, a user may be locked automatically if said user fails to provide valid login credentials. For the purpose of this disclosure, a “locked” user may be a user who cannot access modules that would otherwise be available after the user interface module. The user management module may record the content and number of invalid login attempts. Further, the system may lock the user after a pre-determined number of failed attempts. As a non-limiting example, the user may be locked after three failed attempts. However, the user may be locked after any suitable number of failed attempts. In one embodiment, the user is completely locked out from the system (for example, unable to access any component of the system). However, in another embodiment, the user may be enabled to access the user management module, but may not progress further than said module. The process of locking a user may be for security measures (for example, to prevent unauthorized or fraudulent access). In an embodiment, one or more individuals or classes of individuals may be authorized to lock and/or unlock a user. For example, in one embodiment, a super administrator is authorized to and capable of unlocking a user through the user management interface. A pop-up window or other suitable alert may be delivered to notify the user of the invalid login. Further, a pop-up window or other suitable alert may be delivered to the super administrator. Such an administrator notification may require a confirmation of the action. For example, the super administrator may receive an automatic email or other electronic correspondence informing him or her that a user is locked. The notification may direct the administrator to the user management module or may allow the administrator to confirm or reject a decision at the point of the notification (for example, via one or more links provided in the notification).

The user interface module may present an administrator with the option to enable or disable a user. An enabled user may be an active user who can access the system at all times. A disabled user is a user whose account has been deactivated and, thus, cannot access the system. An administrator, for example a super administrator, may enable or disable users via the user management module. In an embodiment, the roles of administrator and super administrator may differ by the fact that only super administrator can manage the user of the system and the administrator cannot. However such a configuration may be a default setting that can be modified by any existing permission in the system. As a non-limiting example, permissions in the system can include manipulating the payroll or importing tips. In effect, permissions may correspond to each action in the system, wherein, further a permission may be mapped to a user role (for example, super administrator, administrator, employee user, etc.).

In an embodiment, the user management module may include a means of filtering. For example, the user interface may display a list of all users. The list or table may include each user and/or corresponding information. Accordingly, the administrator may filter the list or table by any desired attribute. For example, the administrator may filter the list or table by first name, last name, email, creation date, role, status (for example, enabled or disabled), access (for example, locked or unlocked), or any other suitable attribute.

The user management module may include a pagination selection. The pagination selection may be configured to increase or decrease the number of users displayed on the table per page. For example, by default the table may display ten users. However, this view may be modified to display any desired number of users per page. In an embodiment, the pagination selection button may be a dropdown menu where the administrator can select from predetermined numbers of users per page. For example, the dropdown menu may include predetermined increments, such as, 5, 10, 15, 20, 50, and 100 users per page.

Upon accessing the user management module, a user may check their user profile. For example, a user may select their user profile from a navigation bar disposed within the user interface. The user may check their profile to verify and/or update any of the correlating information, such as, their first name, last name, password, and/or email address.

An aspect of the present disclosure may include a role management system. The role management system may include at least one role. A role may include a set of privileges granted to a user. The role management system may include a plurality of functions that are discussed in further detail below.

The role management system may include a “create” function. The create function may allow a user to define and create a new role. In an embodiment, the user defines parameters including role name, role description, and role permissions.

The role management system may include a “read” function. The read function may allow a user to retrieve and display a table. The table may contain a list of existing roles and related information. Such related information may include role name, role description, role creation date, and various actions which may be performed in connection with the role.

In an embodiment, the role management system includes an “update” function. The update function may allow a user to edit existing roles. The update function may allow a user to edit a plurality of role parameters including role name, role description, or role permissions.

As a non-limiting example, when a user is created a role is assigned to said user corresponding to one or more permissions. In such a non-limiting example, when a user logs in to the system said user is only able to observe interfaces or components thereof that are unlocked for the user's assigned role. The system may detect the user's role and hide, alter, or show modules and components thereof according to the role. For example, the Recruiting Role may not access to the payroll module; the HR Role may have access to both recruiting module & payroll module; and/or the Payroll role may have access to the payroll module, but not the recruiting module.

The role management system may include a “delete” function. The delete function may be activated via a “delete” button displayed on a user interface of the role management system. Activating the delete button may cause a pop-up window to appear on the display. The pop-up window may contain a confirmation message asking the user to confirm whether they wish to delete a specific role. A user may then interact with a confirm button displayed in the pop-up window to delete a specific role. Alternatively, the user may interact with a cancel button displayed in the pop-up window to cancel the “delete” action.

In an embodiment, the role management system includes a “pagination” function. The pagination function may allow a user to customize the number of roles displayed in the read function. In an embodiment, a drop-down menu may be displayed on the user interface of the role management system when the read function is active. The drop-down menu may contain a plurality of numbers corresponding to the number of roles the user wishes to be displayed. For example, the drop-down menu may include the numbers 10, 25, 50, 75, or 100. The user may select a number within the drop-down menu to cause the user interface to display the corresponding number of roles. As a non-limiting example, the user may select “50” to cause the user interface to display 50 roles.

In one embodiment, not all users can perform the aforementioned actions, as ability to access such actions may depend on the role of the user and the corresponding role permissions.

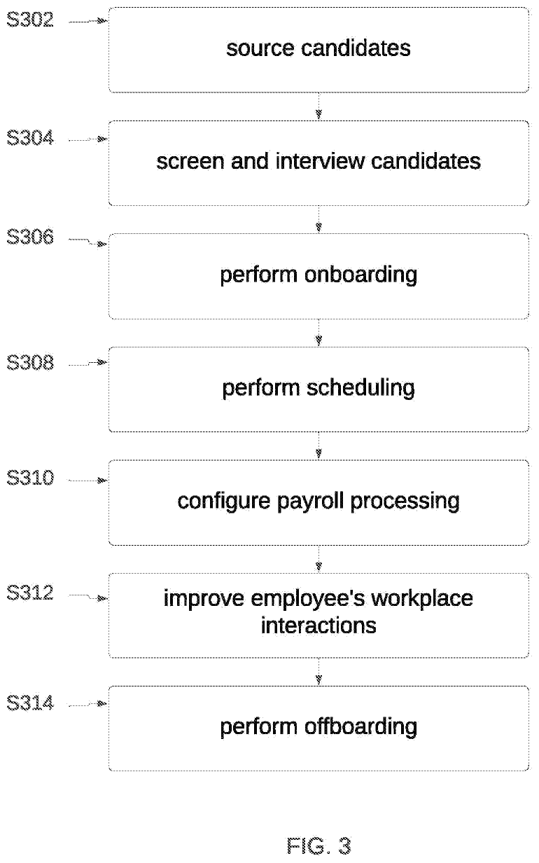

In an embodiment, the System includes a number of steps and/or corresponding modules and/or interfaces. These steps may be implemented in any order, number, or combination. These steps may include or may be supplemented with algorithms, software, programs, or cloud-based applications. These steps may be stored as, or may encompass, computer-readable instructions stored on the memory, to be executed by the processor. For the purposes of this disclosure, the steps as disclosed in FIG. 3 may depict the discrete aspects of the System and an embodiment of utilizing such aspects.

Referring to FIG. 3, in step S302, the system may be configured to source candidates. In an embodiment, this step may utilize a standard Applicant Tracking System (“ATS”). Further, step S302 may utilize an Artificial Intelligence (“AI”) based ATS. Such an AI ATS may encompass a broader reach, for example, configured to search both active and passive job seekers. Thus, the AI ATS may source candidates that have not actively applied for the underlying employment position or may source candidates from the source pool before filtering. In effect, by sourcing candidates from both active and passive seekers, the system may present a greater number of candidates and/or more suitable candidates. The AI ATS, or the step S302 generally, may be configured to analyze applicant's resumes and the content thereof. The System may be configured to receive a depository of applicants, where the depository of applicants include one or more applicants and corresponding resumes or applications. For example, the depository of applicants may be retrieved from a third-party hiring system or from an internal hiring portal. The depository of applicants may be configured as a list (for example, a CSV), a table, and/or a database comprising applicant and application information.

In an embodiment, the AI ATS may utilize a sourcing process (for example, driven by machine learning), a virtual recruitment chat-bot, and/or tailored welcome messages to the employee or applicant. The system may interact with a depository of job applicants. However, the System may also interact with databases of current and prior applicants. The depository of applicants may be derived from a third-party hiring platform and/or from applications submitted directly to the administrator's business. Thus, the depository of applicants may be stored in the database and/or server and may be rewritten as to include past applicants. Therefore, a current depository of applicants may include applicants from any time period. Accordingly, the applicant pool may be widened by including past applicants.

The sourcing of applicants may utilize the AI ATS and/or a virtual chat-bot, wherein the virtual chat-bot is configured to deliver messages to the applicants. The chat-bot may be adapted to deliver messages configured to retrieve data-rich responses from the applicants. Accordingly, the messages may be tailored to desired employee characteristics or other desired traits as submitted by administrators. In a further embodiment, the virtual chat-bot may utilize the microphone and/or camera of the applicant's apparatus 200. For example, the virtual chat-bot may receive audio and/or video from the apparatus 200 and the AI ATS may evaluate said audio and/or video for desired characteristics.

In an embodiment, the system includes a step S304, configured to screen and/or interview applicants, candidates, and/or employees. Accordingly, the one or more candidates may be screened to determine one or more prospective hires. The processes of step S302 may be linked with third party application portals or hiring services (for example, XOR and HIREVUE). In an alternate embodiment, a recruiting team may make phone calls and/or hold group interviews with prospective employees (for example, in order to supplement digital screening and interviewing). An interactive chat-bot may be utilized in recruitment to increase engagement and automate the workflow. For example, the chat-bot may be configured to elicit information-rich responses from the applicants. In another embodiment, the chat-bot may be configured to recommend or condemn an applicant based on pre-determined position criteria. In such an instance, the system administrator and/or employer may determine such pre-determined position criteria. The Recruiting Team may select the pre-determined position criteria. For example, a criterion may exist as a yes/no value, or as a minimum or maximum score. Therefore, administrators may tailor the pre-determined position criteria such that the chat-bot may interact with the one or more prospective hires to retrieve answers correlating to the pre-determined position criteria. Thus, the System may extract the necessary information for the administrator and/or the System to sufficiently evaluate whether the one or more candidates are suitable prospective hires. In an embodiment, the System may include a list of characteristics and corresponding metric thresholds that must be met to convert an individual from a candidate to a prospective hire. For example, an administrator may require in the pre-determined position criteria that an employee is timely for the position of delivery assistant. In such a non-limiting example, the chat-bot may deliver messages, for example, “What time do you wake up in the morning?,” “Have you ever been late to previous jobs?,” or “Do you generally arrive at appointments early?” Then, the System may retrieve the answers and analyze such answers in light of the timeliness characteristics and corresponding timeliness thresholds.

In an embodiment, the system includes step S306, configured to assist and/or perform onboarding (for example, configured to interact with pre-existing services such as, XOR, ADP, HUMANITY, TWIST, and Delivery app). In an alternate embodiment, onboarding may be performed with a hard copy completion of all new hire paperwork and in person orientation/training (for example, to supplement digital employee files or automated profile creation). In an embodiment, onboarding may be performed with digital employee e-filing, automated profile creation, and/or gamification powered training. The onboarding process may transmit a reminder for a new hire, notifying a recruiter as soon as a background check is cleared. In an embodiment, when the background check is complete an email may be generated and sent to the Recruiting Team and/or another individual associated with the System. In a further embodiment, the notification of the background check's clearance may be sent directly the server back end, wherein the back end may further communicate directly to the recruiter. The onboarding process may next enable a job offer to be generated and sent to the new hire. Further, in the onboarding process, the new hire may undergo training, for example, gamification based training. The onboarding process may also automatically create instant availability for scheduling. Finally, the onboarding process may automate the payroll process for the new hire.

The System may request one or more documents from the prospective hire, for example, driver's license, passport, resume, letter of recommendation, DMV driving abstract, other government documents, and/or other suitable documents. Such documents may be utilized by the background check system. In one embodiment, the System may be configured to activate the prospective hire's camera to capture images of the documents. Thus, the prospective hire may more easily submit the document to the System, as opposed to digitizing a paper document and transferring the files by oneself, which may be difficult for some low-skilled workers.

In an embodiment, the system includes a step S308, configured to assist and/or perform scheduling (for example, configured to interact with pre-existing systems such as, HUMANITY or other scheduling tools). In an alternate embodiment, in step S308 the workforce may be scheduled using any existing platform. Additionally, in step S308 scheduling may optimize time management strategy and strategically demand labor. Thus, the scheduling of a particular employee's hours may be based on the availability and work schedule of other employees.

In an embodiment, the system includes a step S310, configured to assist and/or perform payroll management (for example, interacting with the board or other existing systems akin to ADP and DAILYPAY). In an alternate embodiment, traditional payroll management with weekly pay cycles may be utilized. However, step S310 may utilize automated payroll processing, for example, including a daily pay option.

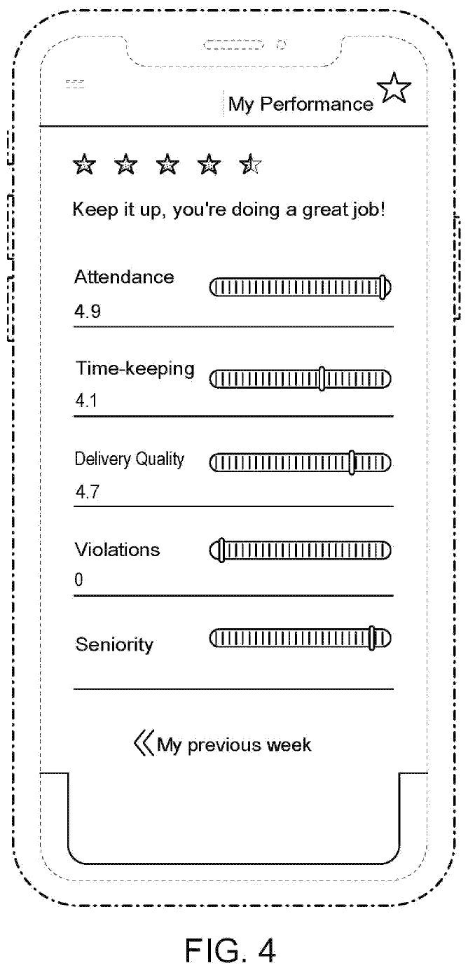

In an embodiment, the system includes a step S312, configured to improve an employee's life at their workplace (for example, providing positive interaction with the board). In an alternate embodiment, attendance and performance monitoring is completed in different and disconnected systems, wherein attendance and performance data is subsequently transmitted to the system. Tailored tools and techniques may be utilized to optimize employee performance and attendance metrics in one system ensuring standards are met and legally compliant. For example, a ranking may be generated powered by a custom algorithm based on an employee's performance metric. The attendance metrics may be a function of the employee's clock in time, clock out time, and the correlation of said clock in time and clock out time with the employee's work schedule. For example, the system may compare the clock in and clock out time with the work schedule to determine whether the employee was late or early to being their shift, or late or early to end their shift. The performance metrics may be a function of at least a set of tasks and/or the employee's completion of said set of tasks. The set of tasks may be the tasks expected to be performed by a particular type of employee or the tasks assigned to the employee to be completed on a particular day or within a certain time period. The automated attendance analysis may utilize previous attendance as a basis for future trends. In step S312, the system may also automate and track the violation management process. As shown in FIG. 4, performance metrics may be visualized and displayed to the employee.

Referring to the violation management process, this module may be responsible for violation of non-payroll aspects. In such a module, there may be one or more parties involved, for example, a shift coordinator and an HR Manager. Each of the one or more parties may have pre-determined privileges within the module. Accordingly, each category of the one or more parties may interact with the module in a different manner. For the purposes of this disclosure, the administrators may be referred to as first and second administrators, wherein each of the first and second administrators have first and second permissions, respectively.

Under the shift coordinator's section of the violation management module, the shift coordinator may create a report for a new violation. In reporting a new violation, the shift coordinator may select the date of the violation and enter details related to it (for example, geolocation, employee ID or employee name, the violation type, and/or a violation description, if necessary). Moreover, a list of reported violations may be generated and maintained. Such a list may be readable by the shift coordinator. After selecting a period of dates (for example, the last two weeks, the last month, year to date, or another selected period), a position, an employee name, and/or a shift coordinator, a list may be populated of all the violations for this period. Further, such a list may include additional details, for example, termination date, date of the violation, and/or total number of violations for each employee. In a further embodiment, more details may be available by selecting a desired employee (for example, the shift coordinator may select an option that presents the employee's position, program, assigned shift coordinator, and/or violation description).

Under the HR manager's section of the violation management module, the HR manager may read the list of reported violations. For example, the HR manager may be able to view the lists of violations as generated by the shift coordinator. The HR manager may be capable of interacting with the violation management aspect, for example, the portion of the violation management configured to manage the violations. The HR manager may further create and/or add a new violation type. Violation types may include failure to attend shift on time, or failure to complete work assignments while on shift. For example, the HR manager may enter values for the corresponding violation ID, violation type, and the company policy for said violation. The description of the violation may be uploaded and defined in the system to be used later in the notification sent to the employee. In an embodiment, there are two ways in which violations may be entered: (1) violations may be detected from data received from other modules (such as an image-to-text module or the payroll module), to which violations are detected automatically based on pre-defined parameters (such as delivery time minimums or maximums); and (2) violations may be manually input by administrator for violations which cannot be detected by a computer system, such as an employee attending work while intoxicated, or an employee wearing inappropriate clothing.

Accordingly, each violation type and violation ID may be unique. Further, the HR manager may be able to utilize the update functionality, enabling the HR manger to edit a violation. In such an embodiment, in the violations list, the HR manager may edit the violation, update the type of violation, and modify the corresponding company policy. The HR manger may add a new type of violation, wherein the violation is unique. Additionally, the HR manager may delete a violation. For example, in the violations list, each violation may include a deletion button, enabling removal of the violation from the violation list. In such an embodiment, removal of a violation can trigger a pop-up window or another alert requiring the HR manager to confirm the action.

The violation management module may include a means of reporting. For example, either an HR manager or a shift coordinator may report violations. In an embodiment, the violation management module may include a means of reporting with charts. After selecting a period of dates, a program, and/or a position, charts may be generated that provide details on the evolution of the violation process. For example, the charts may display the top five violations in the selected period, the top five employees with violations, and the top five positions with violations. The top five violations may refer to give most common violations, the most severe types of violations, or the most recent violation to be reported or to have occurred. In a further embodiment, the top five violations may be violations generally or in gross, and not specific to a certain employee. Thus, this may allow an administrator to view that issues are of most concern to the business. In one embodiment, the violation management module may enable reporting with tables (for example, a global view). In such an embodiment, reporting may utilize tables to have more data and more flexibility for the user: After selecting a period of dates and/or a position, one or more tables may be populated and displayed depicting the top violation type, top employee with violations, and/or top position with violations. In such an embodiment, the tables may enable more flexibility to apply filters and organize data. Moreover, the violation management module may enable reporting violations by a designated time period, for example, years, months, weeks, and/or days. Accordingly, a report may be generated to display violations from the selected time period.

Thus, the System may track, via the one or more processors, violations of each of the one or more employees. Each violation may comprise at least a violation date, a violation time, and a violation type. The violations may be either an automatically detected violation or a manually input violation. For example, the automatically detected violations are evaluated by the one or more processors in view of a predetermined violation criteria set. Accordingly, the automatically detected violations are those that are determined by System in view of metrics that are otherwise measure in the payroll module, violations module, clock-in/clock-out interface, scheduling module, or other adjacent modules. For example, the predetermined violation criteria set may include the violation of being more than ten minute late to work, which may be determined automatically based on check-in time in view of the scheduled start time. Thus, in such an example, the violations module may utilize the clock-in data and information from the scheduling module, to evaluate whether a violation has occurred. The manually input violations may be received via an administrator. For example, manually input violations may be entered to the System via a violations reporting interface.

Each violation may include a violation identification (“ID”), such that each violation is traceable and easily stored and/or retrieved. The system may store, via the one or more computer-readable storage devices, each of the violations and corresponding violation ID in a violation list. Accordingly, the System may generate, via the one or more processors, a violation report comprising the violations and corresponding violation types for the one or more employees.

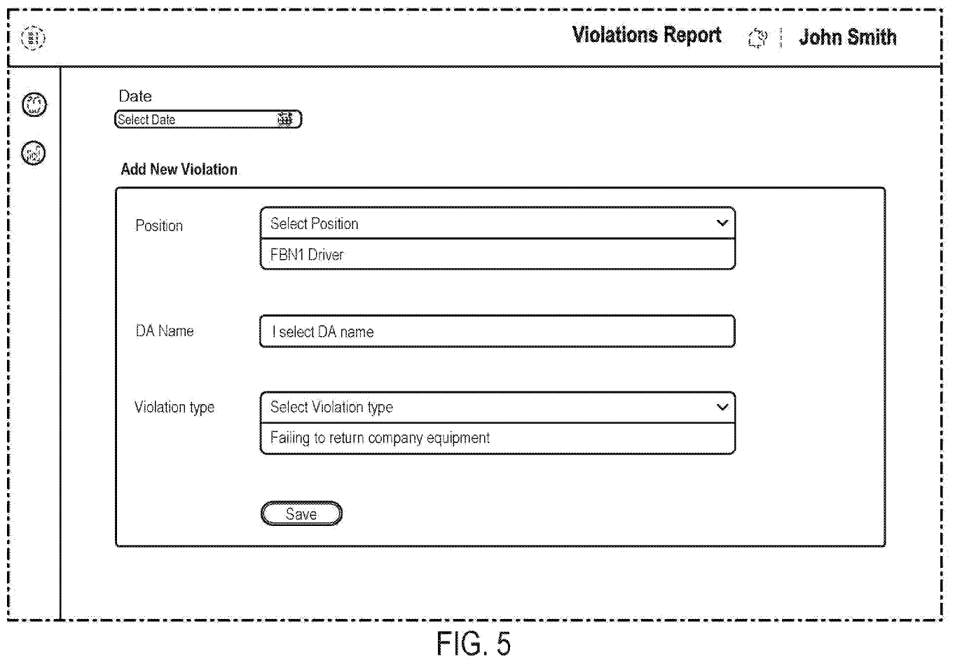

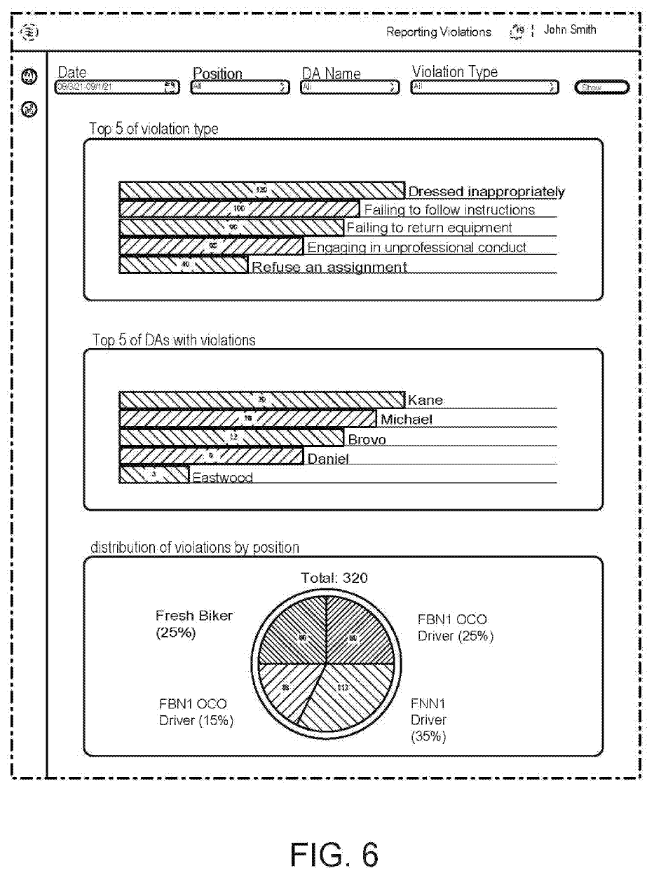

As described above and illustrated in FIG. 5, the system may include a violations report interface wherein a violation may be manually entered by an administrator, for example, a shift coordinator and/or an HR manager. Further, as described above and illustrated in FIG. 6, the system may include a violations metrics interface wherein violations may be amassed, analyzed, and visually represented to the user.

Returning back to FIG. 3, the system may include a step S314, configured to assist and/or perform offboarding (for example, via interaction with the board). In an alternate embodiment, employees may utilize multiple steps in several operating systems to offboard, wherein offboarding data is subsequently transmitted to the system. Step S314 may utilize “one click” offboarding technology, allowing an End-to-End IT powered employment life cycle. The system may allow for automated access for deactivation of an employee from all platforms.

The invention of the present disclosure may further comprise a Tips Import Module. The Tips Import Module may enable importation of tips from a spreadsheet or other data store to the working database for the System. From the frontend of the application, the user of the tips import interface may select the program (for example, if the client has a corresponding program) and at least one valid file (for example, a spread sheet such as an XLSX formatted file). If the user has selected a file that is missing or includes invalid data, a request may not be sent to the server and/or an error message may be delivered to the user.

In an embodiment, tips may be received from a third-party dashboard and/or a third-party payment system. Late tips may be those tips that are paid by the customer such that they process after the end of a particular pay week. For example, if a user pays a tip via credit card or a third-party payment service after the “end of day” on a Friday, and the tip does not process until the following week. In effect, the late tips determination system of the tips module may be adapted to find tips that correlate to a previous week and update the tip database and payment flow, such that the late tips are both properly archived and disbursed to employee.

Similarly, from the system backend, the system may save the name of the files uploaded, the corresponding client, the corresponding program, the user who uploaded the files, and/or the date when the files were uploaded. The System may set the value of the added tips and the invalid tips to zero (for example, as a default). Further, the system may alter the tip importation status to pending. The system may evaluate the validity (a valid file may contain the correct data columns and an invalid file may contain missing data columns, such as tip amount, or may contain a column with an incorrect header name) of the file content. For example, if the file is invalid, the system may generate an error. Further, in such an example, the error may be displayed via the interface to the user. However, if the file is determined to be valid, the system may parse the file and convert it to a usable format (for example, a JSON formatted data set). Further, the system may retrieve an employee from the database with the corresponding email address (which is found in the file), and then save the tips data in the database. If, however, the system cannot determine the identity of the employee via the corresponding email address, the system may display an error (for example, displayed via the interface). In an embodiment, once the system parses and saves the tips, it may update the status of the parsing and the number of tips added and skipped. Additionally, the file may be removed from the server and a message may be generated with the status of the parsing that will be shown in the user interface.

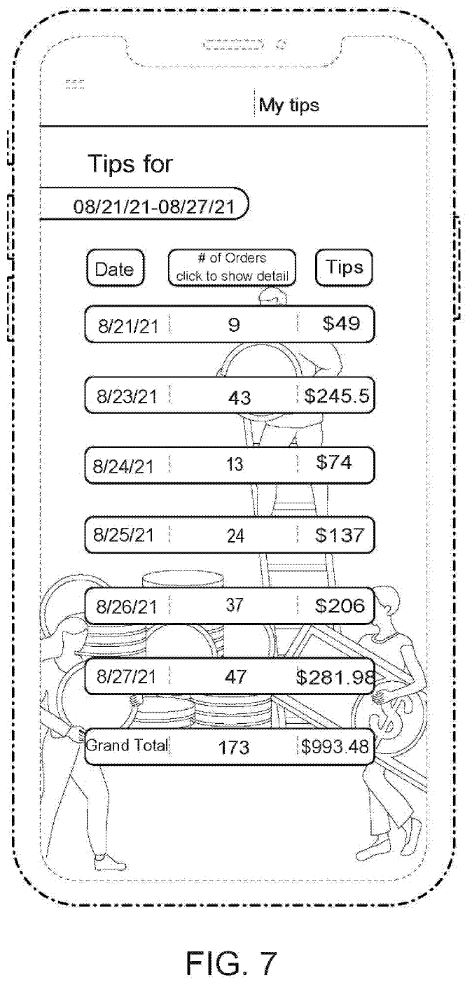

As shown in FIG. 7, the System may generate and display a tips interface for presentation to a user. This tips interface may present the collected tips as correlated to each date.

The system may further comprise a Mapping Payroll Position & Type Module. The payroll management module may enable the user to map a HUMANITY position to a payroll type. Accordingly, after the mapping, the system may determine the payroll type of a specific HUMANITY position. From the frontend, the user may navigate to the mapping position payroll type interface. The interface may present the list of positions. A list of payroll types may be correlated to each position on the interface. Accordingly, the interface may allow the user to select a payroll type for the position he or she wants to map. In the backend, a request may be sent to the server such that the server updates the list of positions already selected for a specific payroll type in the database. In an embodiment, once a position is mapped with a payroll type, the menu may be disabled so the mapping cannot be altered. For example, this may be implemented because a HUMANITY position is associated with a single payroll type. Thus, if the payroll type changes, a new position may be created to maintain the coherence of the original time clock related to the originally selected position.

The system may further comprise a Tips Email Module. The Tips Email Module may enable the system to send emails, at pre-determined intervals, to DAs who have tips. For example, the Tips Email Module may be configured to send emails to such DAs every Thursday. Such emails may include the details of tips from the previous week (current pay week), as well as late tips. In the backend, at a pre-determined time, the server may collect last week's tips from the database. The system may group tips by employee and work date. Thus, the system may further separate the data into late tips and on-time tips. In such an embodiment, this module may facilitate the transmission of tips by email to the corresponding DAs. However, if an error occurred and an email was not sent to the server, the email data may be saved to the database and the system may retry the transmission after a second pre-determined interval (for example, one hour) as long as the number of error retrials is less than an error threshold (for example, three). Although, the emails may be controlled by the system and this module, the transmission of emails may, in part or wholly, utilize a third-party API.

The system may also include a Tips Management Module. The tips module allows the user to see the tips breakdown and to “confirm” tips. Once tips are confirmed they can be included in the pay data batch sent to ADP (or other suitable payment processors). The Tips Management Module may provide a list of tips in a date interval (for example, weekly), wherein the date interval is selected by the user. The Tips Management Module may display the details of tips for each employee in the period corresponding to the selected week. In the frontend, the user may select a year and a week. The system may then populate and display the list of tips of the selected interval. If the filter was invalid, a request may not be sent to the server. In the backend, the server may retrieve the list of tips from the database based on the date interval selected by the user. The server may group tips by employee and work date and may separate tips into tips on time and late tips. Thus, the system may then returns the corresponding data to the frontend, where the user may see a list of tips by employee and filter by program.

In an embodiment, the invention of the present disclosure is a computer system for employment management comprising one or more processors, one or more computer-readable memories, and one or more computer-readable storage devices, and program instructions stored on at least one of the one or more computer-readable storage devices for execution by at least one of the one or more processors via at least one of the one or more computer-readable memories, the stored program instructions causing the one or more processors to receive a depository of applicants, the depository of applicants comprising an application corresponding to each of the one or more applicants. The depository of applicants may be stored as a spreadsheet or other data store in the one or more storage devices in communication with server, System, and/or apparatus 200. In an embodiment, the stored program instructions may further cause the processor to source one or more candidates from the depository of applicants via a virtual chat-bot configured to deliver messages to each of the one or more applicants; and screen, via the one or more processors, the one or more candidates for one or more prospective hires via the virtual chat-bot adapted to filter the one or more candidates based on a predetermined position criteria set; and generate, via the one or more processors, a profile based on each of the one or more prospective hires. The chat-bot may be displayed to the potential employee via the employee device or via any other suitable computerized device. In an embodiment, the stored program instructions may further cause the one or more processors to receive a required documentation (for example, driver's license, employment application, health records, or other related documents) set for each of the one or more prospective hires; generate an offer letter for the one or more prospective hires; transmit the offer letter to the one or more prospective hires; receive an acceptance of the offer letter from one or more employees; and generate, via the one or more processors, and display to the one or more employees, via one or more screens, a gamified training session. The gamified training session may be configured to teach the expectations and characteristics of the position to the potential employee in an interactive manner. For example, the gamified training session may be a digital training session comprising a number of quizzes and/or other interactive elements, for example, utilizing touch screen, camera input, and/or microphone input. In yet a further embodiment, the stored program instructions may cause the one or more processors to set a work schedule for each of the one or more employees; track, via the one or more processors, violations of each of the one or more employees, each violation comprising at least a violation date, a violation time, and a violation type, wherein the violations comprise automatically detected violations and manually input violations, wherein the automatically detected violations are evaluated by the one or more processors in view of a predetermined violation criteria set, and wherein the manually input violations are received via an administrator; create, via the one or more processors, a violation identification (“ID”) for each of the violations; store, via the one or more computer-readable storage devices, each of the violations and corresponding violation ID in a violation list; and generate, via the one or more processors, a violation report comprising the violations and corresponding violation types for the one or more employees.

In another aspect, sourcing the one or more candidates from the depository of applicants may further comprise utilizing an artificial intelligence (“AI”) applicant tracking system (“ATS”). The AI ATS may be trained with training data at the discretion of the administrators. For example, the training data may be tailored to the type or scope of employment. However, in another embodiment, the AI ATS may utilize a generalized training data set adapted to manifest an AI ATS configured to seek the best “general” employee characteristics. The stored program instructions may further comprise performing a background check for each of the one or more prospective hires based on the required documentation set. In a further embodiment, the stored program instructions further comprise associating a payroll schedule with each of the one or more employee profiles, wherein the payroll schedule causes pay disbursements to each of the one or more employees.

In yet a further aspect, the stored program instructions may further comprise monitoring, via the one or more processors, attendance metrics of each of the one or more employees, wherein the attendance metrics of each of the one or more employees are a function of at least a clock in time, a clock out time, and the work schedule. In one embodiment, the stored program instructions further comprise monitoring, via the one or more processors, performance metrics of each of the one or more employees, wherein the performance metrics of each of the one or more employees are a function of at least a set of tasks. In an embodiment, the violations report comprises a violations visualization, and the violations visualization may display a predetermined number of violation types sorted by a frequency of occurrence for each of the violation types by the employees. In an embodiment, the performance metrics may be a function of attendance metrics. For example, the performance metrics may increase as the attendance metrics increase.

In an embodiment, the stored program instructions further comprise generating, via the one or more processors, a violations management module interface editable by a first administrator and a second administrator, wherein edits to the violation management module interface by the first administrator are restricted by a first permission, and wherein edits to the violation management module interface by the second administrator are restricted by a second permission. For example, edits may be made via any smart device or computerized device with access to the System and/or server. In one embodiment, the database regularly records the payroll module, such that previous instances of the payroll module may be recreated if an error manifests or an administrator's action is to be undone. The first permission may be configured to allow entry of a geolocation of one of the manually input violations. The second permission may be configured to allow entry of a violation description of one of the manually input violations. However, the System may be configurable for any number of administrators and, thus, any number or combination of corresponding permissions.

Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A computer system for employment management comprising one or more processors, one or more computer-readable memories, and one or more computer-readable storage devices, and program instructions stored on at least one of the one or more computer-readable storage devices for execution by at least one of the one or more processors via at least one of the one or more computer-readable memories, the stored program instructions comprising:
receive a depository of applicants, the depository of applicants comprising an application corresponding to each of the one or more applicants;
source one or more candidates from the depository of applicants via a virtual chat-bot configured to deliver messages to each of the one or more applicants;
screen, via the one or more processors, the one or more candidates for one or more prospective hires via the virtual chat-bot adapted to filter the one or more candidates based on a predetermined position criteria set;
generate, via the one or more processors, a profile based on each of the one or more prospective hires;
receive a required documentation set for each of the one or more prospective hires;
generate an offer letter for the one or more prospective hires;
transmit the offer letter to the one or more prospective hires;
receive an acceptance of the offer letter from one or more employees;
generate, via the one or more processors, and display to the one or more employees, via one or more screens, a gamified training session;
set a work schedule for each of the one or more employees;
track, via the one or more processors, violations of each of the one or more employees, each violation comprising at least a violation date, a violation time, and a violation type,
wherein the violations comprise automatically detected violations and manual input violations,
wherein the automatically detected violations are evaluated by the one or more processors in view of a predetermined violation criteria set, and
wherein the manual input violations are received via an administrator;
create, via the one or more processors, a violation identification (“ID”) for each of the violation;
store, via the one or more computer-readable storage devices, each of the violations and corresponding violation ID in a violation list; and
generate, via the one or more processors, a violation report comprising the violations and corresponding violation types for the one or more employees.

2. The computer system of claim 1, wherein sourcing the one or more candidates from the depository of applicants further comprises utilizing an artificial intelligence (“AI”) applicant tracking system (“ATS”).

3. The computer system of claim 1, the stored program instructions further comprising:
perform a background check for each of the one or more prospective hires based on the required documentation set.

4. The computer system of claim 1, the stored program instructions further comprising:
associate a payroll schedule with each of one or more employee profiles,
wherein the payroll schedule causes pay disbursements to each of the one or more employees.

5. The computer system of claim 1, the stored program instructions further comprising:
monitor, via the one or more processors, attendance metrics of each of the one or more employees,
wherein the attendance metrics of each of the one or more employees are a function of at least a clock in time, a clock out time, and the work schedule.

6. The computer system of claim 5, the stored program instructions further comprising:
monitor, via the one or more processors, performance metrics of each of the one or more employees,
wherein the performance metrics of each of the one or more employees are a function of at least a set of tasks.

7. The computer system of claim 6, wherein the violations report comprises a violations visualization, and wherein the violations visualization displays a predetermined number of violation types sorted by a frequency of occurrence for each of the violation types by the employees.

8. The computer system of claim 7, the stored program instructions further comprising:
generate, via the one or more processors, a violations management module interface editable by a first administrator and a second administrator,
wherein edits to the violation management module interface by the first administrator are restricted by a first permission, and
wherein edits to the violation management module interface by the second administrator are restricted by a second permission.

9. The computer system of claim 8, wherein the first permission is configured to allow entry of a geolocation of one of the manually input violations.

10. The computer system of claim 8, wherein the second permission is configured to allow entry of a violation description of one of the manually input violations.
